(19) United States
(12) Patent Application Publication
(10) Pub. No.: US 2016/0304368 A1
(43) Pub. Date: Oct. 20, 2016

(54) Method of Processing Biological Culturing Water by Using Active Photocatalytic Reactor

(71) Applicant: National Applied Research Laboratories, Taipei (TW)

(72) Inventors: Din-Ping Tsai, Hsinchu (TW); Hung-Ji Huang, Hsinchu (TW); Chun-Ting Lin, Hsinchu (TW)

(21) Appl. No.: 15/193,246

(22) Filed: Jun. 27, 2016

Related U.S. Application Data
(63) Continuation of application No. 13/343,754, filed on Jan. 5, 2012.

(51) Int. Cl. C02F 1/72; C02F 1/32; B01J 35/02; B01J 21/06; B01J 35/00

(52) U.S. Cl. CPC C02F 1/725; B01J 21/063; B01J 35/004; B01J 35/02; C02F 1/32; C02F 2101/16

(57) ABSTRACT

An active photocatalytic reactor configured to process biological culturing water with an accelerated process. Water to be used in a biological culturing system is stabilized with pollutants in the water reduced. The active photocatalytic reactor is less affected by outside environment while having faster activating speed. The active photocatalytic reactor can further be combined with a traditional filter to form a serial or parallel connection for more effectively purifying the culturing water with damage to the whole system avoided.

### RELATED APPLICATIONS

This application is a continuation-in-part of application Ser. No. 13/343,754 filed Jan. 5, 2012.

### FIELD OF THE INVENTION

Embodiments relate to processing culturing water; more particularly, relate to processing culturing water by using a photocatalytic reactor for obtaining stable water to be used in a biological culturing system.

### DESCRIPTION OF THE RELATED ARTS

Atmospheric discharge of CO₂ and possible deleterious greenhouse effects on Earth climate are under serious study. Some studies are revealed concerning solutions by using semiconductor photocatalysts like TiO₂, SiC, GaP, etc. to reduce CO₂ with products like HCHO, CH₃OH, etc. by processing photocatalytic reduction reactions. In reactions coordinated with slurry bed reactors, photocatalyst particles are uniformly mixed with reactant solutions to effectively process photocatalytic reduction reactions. Systems used for such a reaction have high performance, but the photocatalyst has to be recycled and the procedure becomes complex with increased reaction time and cost. In addition, the photocatalyst needs to have enough illuminated area for mass-productive optical catalysis reaction. Because TiO₂ has a high shielding ratio to light, ultra-violet (UV) light only has a transmission thickness of 1-2 centimeters (cm) in a TiO₂-suspending gel solution, where TiO₂ located farther than 1-2 cm in water is not effectively reacted and processing efficiency of incident light is thus greatly diminished if not absorbed and used by the TiO₂ particles.

In 1977, Marinangeli and Ollis revealed a fiber optic photocatalytic reactor. Therein, TiO₂ photocatalyst is adhered on a surface of a glass optical fiber. Reactants are contacted with a surface of the TiO₂ film and light is transferred in the optical fiber. Thus, the TiO₂ photocatalyst absorbs the propagating incident light and processes a photocatalytic reaction to the material adjacent. In U.S. Pat. Nos. 5,875,384, 5,919,422, and 6,238,630, a TiO₂-coated fiber optic cable reactor uses a LED or a lamp as a light source to obtain a high processing performance with a small-sized reactor. However, the TiO₂-coated fiber optic cable reactor is fixed in a reaction chamber and a low mass transfer rate of reactant to the surface of TiO₂ photocatalyst results in low processing efficiency.

In U.S. Pat. Nos. 5,480,524, 5,308,458, and 5,689,798 and scientific research results presented by H. C. Yatmaz et al. (Chemosphere 42 (2001) 397±403), a rotating-bed reactor uses centrifugal force to increase mass transfer rate and reaction performance of a reactant. With a light source located outside of a reactive area, a photocatalytic reduction reaction has a bad performance under a situation of low penetrating rate of light. A photocatalytic reactor with movable conformal light guide plate (U.S. Pat. No. 7,927,553) can be used to accelerate photocatalytic reactions. In U.S. patent application Ser. No. 12/913,212, a compound material capable of expanding light absorption range of original constitutional material successfully implants TiO₂ on a plastic substrate. This can be used to fabricate a photocatalytic optical disk for reducing organic pollutants in water solution.

For intensive farming of land or sea animals, culturing water is very important. In U.S. Pat. Nos. 7,407,793 and 7,407,793, nitrifying bacteria are used to reduce ammonium or nitrogen organic contaminations in water. As revealed in U.S. Pat. No. 7,351,527, viruses in water need to be diminished and isolated to ensure health of Cyprinus carpio on culturing. Prior arts of floating island planters and water cycling and filtering systems are used to filter out ammonium or nitrogen contaminations in water. As revealed in U.S. Pat. Nos. 7,241,373, 7,052,600, and 7,018,543, electrochemical methods are used to reduce organic pollutant in water.

When culturing artiodactyls and birds, volatiles of fermented liquid, gas and/or solid excrements may cause serious pollution. Through proper washing process, some materials in the excrements can be dissolved in water and a large part of harmful components is largely diminished through photocatalytic reaction.

On diminishing organic pollution, photocatalysts can play an important role. In U.S. Pat. Nos. 6,531,100, 5,736,055, 6,238,631, 6,932,947, and 7,230,255, various kinds of photocatalysts are disclosed for purifying water. However, fixed-bed reactors still have low efficiency even using methods revealed e.g. in U.S. Pat. No. 4,956,754 and No. 6,547,963 for increasing reaction effects by increasing staying time of liquids in photocatalytic reacting areas and by increasing time for stirring liquids. In an intensive farming system (especially for aquaculture), a great amount of pollution may be produced by too much animal feed, ever-changing temperature, and/or a sudden increase in bacteria. In addition, pollutant density in discharged sewage for culturing land animals can be extremely high so as to cause environment pollution and offensive smells.

Hence, the prior arts do not fulfill all users' requests on actual use.

### SUMMARY OF THE INVENTION

Embodiments are an extended application of green technologies such as chemical engineering, environmental engineering, aquaculture engineering, etc. By using an active photocatalytic reactor, culturing water is treated quickly with high efficiency to achieve more stability in a biological culturing system. The active photocatalytic reactor comprises a UV lamp source, a photocatalyst, a photocatalyst carrier and a photocatalyst carrier motion activator. The active photocatalytic reactor can be a spin-disk reactor (U.S. Pat. No. 7,927,553); a Taylor-vortex reactor with co-spindle tubes (U.S. Pat. Nos. 5,790,934 and 7,507,370); a vibrating reactor (Japan patent No. WO 03/037504 A1); or a rotating-fin reactor (U.S. Pat. No. 7,704,465).

The photocatalyst is preferably fixed on the photocatalyst carrier and, thus, the photocatalyst carrier can drive the photocatalyst in various motions as motivated by an external motivator and/or self-movement. However, typical slurry-bed and fixed-bed reactors use different mechanisms. In a typical slurry-bed reactor, photocatalyst particles are homogeneously suspended in water with dissolved pollutants. The photocatalyst particles and water may drive in the same motion. In a fixed-bed reactor, the photocatalyst is only fixed on the stilled carrier and processes pollutants in water around the photocatalyst itself.

The active photocatalytic reactor can be combined with an extra filter to greatly reduce influence from outer environment, to more effectively purify culturing water, and to further avoid damage of the whole system.

One purpose of embodiments is to use an active photocatalytic reactor to process culturing water, where the active photocatalytic reactor saves energy and has high performance on fast processing the culturing water to be used in a biological culturing system.

Another purpose of embodiments is to use various motions of photocatalyst carrier and photocatalyst to increase mass transfer rates of pollutants in water, where an operational efficiency of the photocatalyst is greatly speeded up on processing the culturing water as compared to a typical slurry-bed or fixed-bed reactor.

A further purpose of embodiments is to use an active photocatalytic reactor to reduce pollutants in solid and/or gas phases with a water-washing pretreatment, where a processing functional of the active photocatalytic reactor is expended.

An additional purpose of embodiments is to carry on the active photocatalytic reactor with various light sources under minor modifications, where solar light can be an activating light source for photocatalytic pollutant elimination reaction in areas of sufficient sun-light. A light emitting diode (LED) can also be a light source to induce or assist the photocatalytic process.

Embodiments also flexibly assemble the active photocatalytic reactor with other utilities for fitting local environment and reaching an optimized operational convenience.

The active photocatalytic reactor used for maintaining culturing water is embedded in an intensive farming system to stabilize water quality and reduce waste water. The active photocatalytic reactor can be used to replace a purification utility or to coordinate with a traditional purification utility.

To achieve the above purposes, embodiments include a method of processing culturing water using an active photocatalytic reactor and a biological culturing system wherein culturing water is input into the active photocatalytic reactor to purify waste material in the culturing water and directed onto a surface of a photocatalyst disk of the active photocatalytic reactor to a depth not exceeding 5 mm, wherein the surface of the moving photocatalyst disk comprises fixed photocatalyst and wherein the disk is smaller than 50 cm in diameter and rotates at more than 100 rpm; and irradiating the surface of the moving photocatalyst disk and the culturing water with a ultra-violet (UV) lamp so as to purify the culturing water; wherein the waste material is a compound or a combination of compounds selected from a group consisting of NH₄, NH₃, NH₂ and NH; and wherein, after purifying the culturing water, the culturing water is recycled to be outputted from the active photocatalytic reactor. Embodiments also include a method of processing culturing water using a backup active photocatalytic reactor with a reactor inlet and outlet and a biological culturing system with a culturing system inlet and outlet wherein the culturing system inlet is connected with the reactor outlet via a first circuit and wherein the culturing system outlet is connected with the reactor inlet through a second circuit and wherein culturing water is input into the active photocatalytic reactor to purify waste material in the culturing water and directed onto a surface of a photocatalyst disk of the active photocatalytic reactor to a depth not exceeding 5 mm, wherein the surface of the moving photocatalyst disk comprises fixed photocatalyst and wherein the disk is smaller than 50 cm in diameter and rotates at more than 100 rpm; and irradiating the surface of the moving photocatalyst disk and the culturing water with a ultra-violet (UV) lamp so as to purify the culturing water; wherein the waste material is a compound or a combination of compounds selected from a group consisting of NH₄, NH₃, NH₂ and NH; and wherein, after purifying the culturing water, the culturing water is recycled to be outputted from the active photocatalytic reactor. Accordingly, an inventive method of processing biological culturing water by using an active photocatalytic reactor is obtained.

### BRIEF DESCRIPTIONS OF THE DRAWINGS

Better understanding will be obtained from the following detailed descriptions of the preferred embodiments, taken in conjunction with the accompanying drawings, in which

FIG. 1A is a perspective view showing one embodiment;

FIG. 1B is a perspective showing a state-of-use of an active photocatalytic reactor;

FIG. 2 is a table showing reaction products of ammonia and ammonium chloride;

FIG. 3 is a perspective view showing another embodiment; and

FIG. 4 is a perspective view showing a further embodiment.

### DETAILED DESCRIPTION OF EMBODIMENTS

The following descriptions are provided to understand features and structures of embodiments of the recited invention.

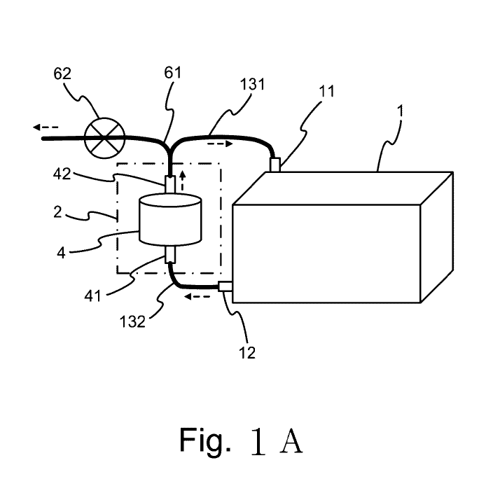

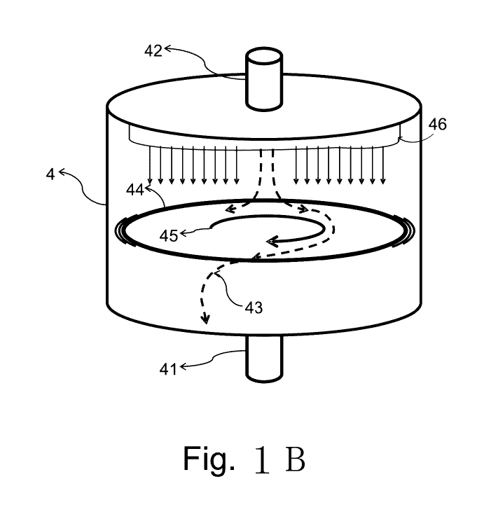

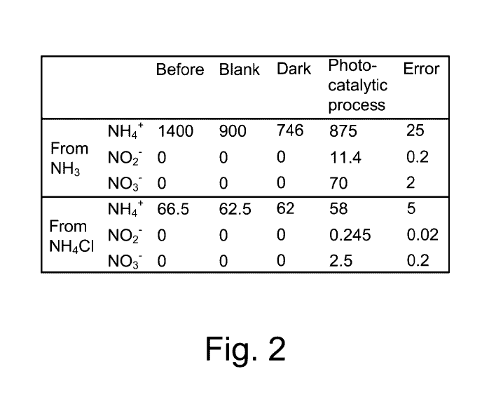

Please refer to FIG. 1A, FIG. 1B and FIG. 2, which are a view showing a first preferred embodiment; a view showing a state-of-use of an active photocatalytic reactor; and a table showing reaction products of ammonia and ammonium chloride. As shown in the figures, embodiments include a method of processing biological culturing water using an active photocatalytic reactor.

One embodiment uses an apparatus comprising a biological culturing system 1 and a culturing-water waste reduction system 2 connected with the biological culturing system 1, where the culturing-water waste reduction system 2 contains an active photocatalytic reactor 4; the biological culturing system 1 has a culture system inlet 11 and a culture system outlet 12; the active photocatalytic reactor 4 has a photocatalytic reactor inlet 41 and a photocatalytic reactor outlet 42; the culture system inlet 11 is connected with the photocatalytic reactor outlet 42 through a first cycling route 131; the culture system outlet 12 is connected with the photocatalytic reactor inlet 41 through a second cycling route 132; and the photocatalytic reactor outlet 42 is connected with a draining tube 61 having a control valve 62.

The active photocatalytic reactor 4 has different inner structures for different forms comprising a photocatalyst disk 44, a photocatalyst carrier motion activator 45, and one or more lamps 46. With a spinning-disk reactor, culturing water 43 (shown in dashed lines in FIG. 1B) enters into the active photocatalytic reactor 4 through the photocatalytic reactor inlet 41 to be directed to an upper surface of the photocatalyst disk 44. The photocatalyst disk 44 is driven by the photocatalyst carrier motion activator 45 to rotate for uniformly distributing the culturing water 43 on the upper surface of the photocatalyst disk 44.

Preferably, culturing water 43 is input into the active photocatalytic reactor 4 to purify waste material entrained in the culturing water 43 and directed onto the upper surface of the photocatalyst disk 44 of the active photocatalytic reactor 4 to a depth of culturing water 43 (as shown in dashed lines) on the upper surface of the photocatalyst disk 44 not exceeding 5 mm. The surface of the moving photocatalyst disk 44 comprises fixed photocatalyst and the disk 44 is smaller than 50 cm in diameter and rotates at more than 100 rpm.

When excessive portions of the culturing water 43 might otherwise accumulate on the surface of the photocatalyst disk 44, any excess portion of the culturing water 43 leaves the surface of the photocatalyst disk 44 due to centrifugal force and is collected in the active photocatalytic reactor 4 to be directed to the photocatalytic reactor outlet 42 and outputted out of the active photocatalytic reactor 4.

By activating activity of photocatalyst(s) on the surface of the photocatalyst disk 44 through irradiation of the lamp(s) 46, entrained pollution in the culturing water 43 is reduced/reacted. In one embodiment, the lamp 46 comprises a ultra-violet (UV) lamp. In one embodiment, the lamp 46 comprises one or more visible spectrum light source(s), such as halogen and/or LED lamps and having wavelength(s) in the approximately 400-700 nm range. In some embodiments, the lamp 46 comprises a plurality of light sources having differing wavelengths.

Thus, the culturing water of the biological culturing system 1 is transferred to the photocatalytic reactor inlet 41 of the active photocatalytic reactor 4 from the culture system outlet 12 through the second cycling route 132 for purifying a compound or a combination of compounds in the culturing water, where the compound is NH₄, NH₃, NH₂ or NH. The culturing water has a pH value maintained between 6 and 8 for operation. Then, the purified culturing water is transferred to the culture system inlet 11 from the photocatalytic reactor outlet 42 through the first cycling route 131 to be used in the biological culturing system 1. The above processes are repeated cyclically, where the culturing water is outputted to the active photocatalytic reactor 4 and then are inputted into the biological culturing system 1 from the active photocatalytic reactor 4.

The biological culturing system 1 is adapted as a culture system for land- and/or aqua-biological intensive farming. According to types and amounts of waste produced, the system can be a closed one or a semi-closed one. For example, if the produced waste is solid or gaseous, water washing is processed at first to dissolve pollutants into water and then the water with entrained pollutants is directed to the outwardly connected culturing-water waste reduction system 2. If the waste produced is liquid and contains big solid particles, the waste is filtered when being directed to the culture system outlet 12 (e.g. before entering into the photocatalytic reactor inlet 41) to avoid damaging different types of the photocatalyst carrier in the active photocatalytic reactor 4 or removing photocatalyst fixed on the active photocatalytic reactor 4.

The culturing-water waste reduction system 2 is used to purify the culturing water and/or waste water for recycling and/or is discharged through the draining tube 61 with the control valve 62 and directed into a waste water processing system for subsequent processing.

The active photocatalytic reactor 4 can be a spin-disk reactor for speeding-up photocatalytic pollutant-reducing oxidation for ammonia in water, where ammonium ions from a plurality of different sources are both effectively diminished.

The spin-disk active photocatalytic reactor 4 processes the photocatalytic pollutant-reducing oxidation of ammonia in water. A syringe pump injects a diluted water solution having ammonium ions on a spin disk irradiated by two 4 watt (W) low-pressure mercury tube lamps, where the spin disk has a rotational speed of 300 revolutions per minute (rpm) and the diluted water solution has an injecting speed of 2 milliliter per minute (mL/min). The spin disk is adhered with a TiO₂ photocatalyst on at least an upper surface thereof and the TiO₂ photocatalyst is activated by a 254 nanometers (nm) UV light, e.g. from lamps 46, to oxidize ammonia in culturing water into nitrites and nitrates. The first kind of ammonium ions comes from a water solution of ammonia gas and the second kind of ammonium ions comes from a water solution of ammonium chloride.

In FIG. 2, 1400±25 milligrams per liter (mg/L) of the first kind of ammonium ions is reduced to 875±25 mg/L and is transformed into 11.4±0.02 mg/L of nitrate and 70±1 mg/L of nitrite and 62.5±5 mg/L of the second kind of ammonium ions is reduced to 58±5 mg/L and is transformed into 0.245±0.02 mg/L of nitrate and 2.5±0.2 mg/L of nitrite.

For the two different kinds of ammonium ions, oxidation does not happen if the photocatalyst and the UV light do not co-exist; that is, no nitrite and no nitrate are obtained. Thus, the spin-disk active photocatalytic reactor is used to rapidly oxidize ammonium ions in water into nitrate and nitrite. The active photocatalytic reactor further controls a ratio of nitrate to nitrite. Nitrate is usually an intermediate product on fully oxidizing ammonium ions into nitrite. The ratio of nitrate to nitrite can be maintained between 7 and 10. Because nitrate is more toxic to water-borne life, high efficiency of oxidizing nitrate into nitrite provides confirmed reduction of toxicity of a culturing environment and further maintains stability of that environment.

Embodiments have the following advantages:

1. A short start-up time, where waiting time for culturing is short and ambient environment does not strongly affect capability of photocatalyst.

2. A short response time, where sudden changes in quality of culturing water can be handled to avoid damage.

3. Provision for coordination with a test-and-feedback control system, where operative parameters of the active photocatalytic reactor can be adjusted for processing culturing water under different pollution rates.

4. Use of an active photocatalytic reactor for reducing pollutant in culturing water, where function of the reactor is not limited by the photocatalyst used in the reactor and the light source used for activating the photocatalyst. Thus, materials which can be reduced or transformed by various photocatalytic reactions are reduced.

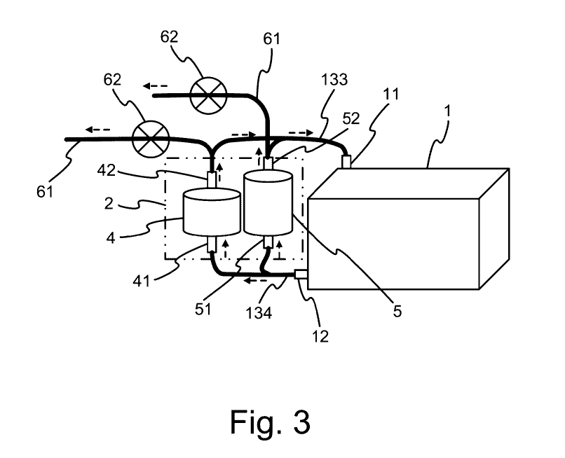

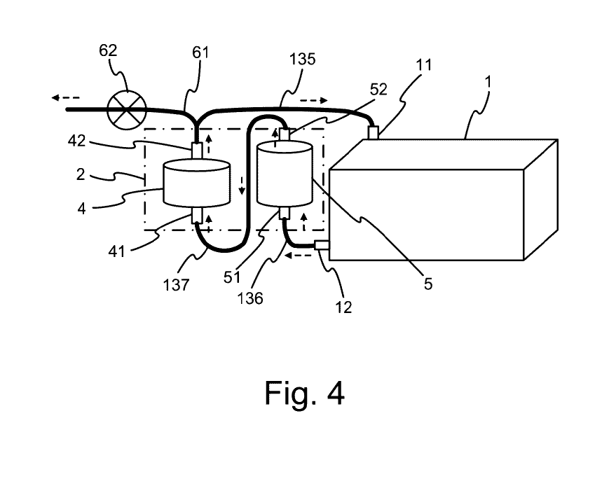

Please further refer to FIG. 3 and FIG. 4, which are views showing a second and a third preferred embodiment respectively. As shown in the figures, the culturing-water waste reduction system 2 contains the active photocatalytic reactor 4, where, if necessary, a water filter 5 can be added under a parallel connection or a serial connection for forming a more stable and less interfered system.

In FIG. 3, the water filter 5 is combined between the biological culturing system 1 and the active photocatalytic reactor 4, where the water filter 5 has a water filter inlet 51 and a water filter outlet 52; the culture system inlet 11 is connected with the photocatalytic reactor outlet 42 and the water filter outlet 52 through a third cycling route 133; the culture system outlet 12 is connected with the photocatalytic reactor inlet 41 and the water filter inlet 51 through a fourth cycling route 134; a parallel connection is thus formed with the biological culturing system 1, the active photocatalytic reactor 4 and the water filter 5; and, the photocatalytic reactor outlet 42 and the water filter outlet 52 are separately connected with draining tubes 61 each having a control valve 62. Thus, the water filter 5 can be used to purify the culturing water.

In FIG. 4, the water filter 5 is combined between the biological culturing system 1 and the active photocatalytic reactor 4, where the water filter 5 has a water filter inlet 51 and a water filter outlet 52; the culture system inlet 11 is connected with the photocatalytic reactor outlet 42 through a fifth cycling route 135; the culture system outlet 12 is connected with the water filter inlet 51 through a sixth cycling route 136; the photocatalytic reactor inlet 41 is connected with water filter outlet 52 through a seventh cycling route 137; a serial connection is thus formed with the biological culturing system 1, the active photocatalytic reactor 4 and the water filter 5; and, the photocatalytic reactor outlet 42 is connected with a draining tube 61 having a control valve 62. Thus, the water filter 5 can be used to purify the culturing water.

Nevertheless, embodiments can be added with systems for temperature control, humidity control, auto-feeding in biological culturing system, etc. according to requirements.

The preferred embodiments herein disclosed are not intended to unnecessarily limit the scope of the recited invention. Therefore, simple modifications or variations belonging to the equivalent of the scope of the claims and the instructions disclosed herein for a patent are all within the scope of the recited invention.

What is claimed is:

1. A method of processing culturing water using an active photocatalytic reactor and a biological culturing system wherein culturing water is input into the active photocatalytic reactor to purify waste material in the culturing water and directed onto a surface of a photocatalyst disk of the active photocatalytic reactor to a depth not exceeding 5 mm, wherein the surface of the moving photocatalyst disk comprises fixed photocatalyst and wherein the disk is smaller than 50 cm in diameter and rotates at more than 100 rpm; and
irradiating the surface of the moving photocatalyst disk and the culturing water with a ultra-violet (UV) lamp so as to purify the culturing water;
wherein the waste material is a compound or a combination of compounds selected from a group consisting of NH₄, NH₃, NH₂ and NH; and
wherein, after purifying the culturing water, the culturing water is recycled to be outputted from the active photocatalytic reactor.

2. The method of claim 1, wherein the biological culturing system has a culture system inlet and a culture system outlet; wherein the active photocatalytic reactor has a photocatalytic reactor inlet and a photocatalytic reactor outlet; wherein the culture system inlet is connected with the photocatalytic reactor outlet through a first cycling route; and wherein the culture system outlet is connected with the photocatalytic reactor inlet through a second cycling route.

3. The method of claim 2, wherein the photocatalytic reactor outlet is connected with a draining tube having a control valve.

4. The method of claim 2, wherein a water filter is further combined between the biological culturing system and the active photocatalytic reactor and the water filter has a water filter inlet and a water filter outlet; and wherein the culture system inlet is connected with the photocatalytic reactor outlet and the water filter outlet through a third cycling route; the culture system outlet is connected with the photocatalytic reactor inlet and the water filter inlet through a fourth cycling route; and a parallel connection is thus obtained with the biological culturing system, the active photocatalytic reactor and the water filter.

5. The method of claim 4, wherein the photocatalytic reactor outlet and the water filter outlet are separately connected with draining tubes each having a control valve.

6. The method of claim 2, wherein a water filter is further combined between the biological culturing system and the active photocatalytic reactor and the water filter has a water filter inlet and a water filter outlet; and wherein the culture system inlet is connected with the photocatalytic reactor outlet through a fifth cycling route; the culture system outlet is connected with the water filter inlet through a sixth cycling route; the photocatalytic reactor inlet is connected with the water filter outlet through a seventh cycling route; and a serial connection is thus obtained with the biological culturing system, the active photocatalytic reactor and the water filter.

7. The method of claim 6, wherein the photocatalytic reactor outlet is connected with a draining tube having a control valve.

8. The method of claim 1, wherein the culturing water has a pH value between 6 and 8.

9. The method of claim 1, comprising inducing any excess culturing water to leave the surface of the rotating photocatalyst disk via centrifugal force.

10. The method of claim 1, comprising directing the culturing water onto an upper surface of the rotating photocatalyst disk.

11. The method of claim 1, comprising irradiating an upper surface of the rotating photocatalyst disk with the UV lamp.

12. A method of processing culturing water using a backup active photocatalytic reactor with a reactor inlet and outlet and a biological culturing system with a culturing system inlet and outlet
wherein the culturing system inlet is connected with the reactor outlet via a first circuit and wherein the culturing system outlet is connected with the reactor inlet through a second circuit and wherein culturing water is input into the active photocatalytic reactor to purify waste material in the culturing water and directed onto a surface of a photocatalyst disk of the active photocatalytic reactor to a depth not exceeding 5 mm, wherein the surface of the moving photocatalyst disk comprises fixed photocatalyst and wherein the disk is smaller than 50 cm in diameter and rotates at more than 100 rpm; and
irradiating the surface of the moving photocatalyst disk and the culturing water with a ultra-violet (UV) lamp so as to purify the culturing water;
wherein the waste material is a compound or a combination of compounds selected from a group consisting of NH₄, NH₃, NH₂ and NH; and
wherein, after purifying the culturing water, the culturing water is recycled to be outputted from the active photocatalytic reactor.

13. The method of claim 12, wherein the reactor outlet is connected with a draining tube having a control valve.

14. The method of claim 12, further comprising a first water filter connected between the biological culturing system and the reactor and wherein the water filter has a water filter inlet and a water filter outlet; and wherein the culturing system inlet is connected with the reactor outlet and the water filter outlet through a third circuit; and the culturing system outlet is connected with the reactor inlet and the water filter inlet through a fourth circuit so as to define a back-up parallel connection of the biological culturing system, the reactor and the water filter.

15. The method of claim 14, wherein the reactor outlet and the water filter outlet are separately connected with draining tubes each having a control valve.

16. The method of claim 14, further comprising a second water filter connected between the culturing system and the reactor and the second water filter has an inlet and outlet; and wherein the culturing system inlet is connected with the outlet through a fifth circuit; the culturing system outlet is connected with the water filter inlet through a sixth circuit; the reactor inlet is connected with the water filter outlet through a seventh circuit; so as to define a serial connection of the biological culturing system, the reactor and the water filter.

17. The method of claim 16, wherein the reactor outlet is connected with a draining tube having a control valve.

18. The method of claim 12, comprising inducing any excess culturing water to leave the surface of the rotating photocatalyst disk via centrifugal force.
